(19) United States
(12) Patent Application Publication
(10) Pub. No.: US 2026/0249685 A1
(43) Pub. Date: Aug. 27, 2026

(54) VEHICLE

(71) Applicant: KAWASAKI MOTORS, LTD., Hyogo (JP)

(72) Inventors: Shohei TERAI, Hyogo (JP); Kouji ITO, Hyogo (JP); Osamu TANI, Hyogo (JP); Takenori SEGAWA, Hyogo (JP); Yoshiki HISAMOTO, Hyogo (JP)

(73) Assignee: KAWASAKI MOTORS, LTD., Hyogo (JP)

(21) Appl. No.: 19/541,422

(22) Filed: Feb. 17, 2026

Related U.S. Application Data
(60) Provisional application No. 63/761,319, filed on Feb. 21, 2025.

(51) Int. Cl. B60K 28/16; B60W 30/18; B60W 40/105

(52) U.S. Cl. CPC B60K 28/16; B60W 30/18; B60W 40/105; B60W 2520/10

(57) ABSTRACT

A vehicle includes a controller. The vehicle is an off-road vehicle configured to be able to travel over rough terrain, and the controller is configured to estimate a vehicle position based on a slip state of the vehicle. The vehicle position is a current position of the off-road vehicle.

### CROSS-REFERENCE TO RELATED APPLICATION

This application claims the benefit of priority to U.S. Provisional Application No. 63/761,319 filed on Feb. 21, 2025, the entire contents of which are incorporated by reference herein.

### TECHNICAL FIELD

The present disclosure relates to a vehicle.

### BACKGROUND OF THE INVENTION

In JP 2020-013379 A, an operation system is disclosed of a vehicle capable of automatic operation that travels on a predetermined travel route based on a predetermined operation plan. In this system, using information including position information from a plurality of electric vehicles capable of the automatic operation, output values of sensors mounted in each of the vehicles are compared, and the operation plan including the route and speed is re-constructed.

### SUMMARY OF THE INVENTION

According to a first aspect of the present disclosure, a vehicle is provided. The vehicle is an off-road vehicle capable of traveling over rough terrain. The vehicle includes a controller. The controller is configured to estimate a vehicle position based on a slip state of the vehicle, the vehicle position being a current position of the vehicle.

According to a second aspect of the present disclosure, a vehicle is provided. The vehicle includes a traveling device configured to cause the vehicle to travel, a controller configured to control the traveling device and cause the vehicle to travel autonomously, and a vehicle position detection unit configured to detect a vehicle position and output the vehicle position to the controller, the vehicle position being a current position of the vehicle. When the vehicle is in a lost signal state of the vehicle position not being acquirable from the vehicle position detection unit, the controller is configured to execute vehicle speed limit processing that reduces a vehicle speed of the vehicle.

### BRIEF DESCRIPTION OF DRAWINGS

FIG. 1 is a schematic configuration view of a vehicle.

FIG. 2 is a system configuration view of the vehicle.

FIG. 3 is a flowchart showing an example of route planning processing.

FIG. 4 is a flowchart showing an example of vehicle position and vehicle speed acquisition processing.

FIG. 5 is a flowchart showing an example of average slip rate calculation processing.

FIG. 6 is an example of a flowchart of vehicle position and vehicle speed estimation processing.

### DETAILED DESCRIPTION OF THE INVENTION

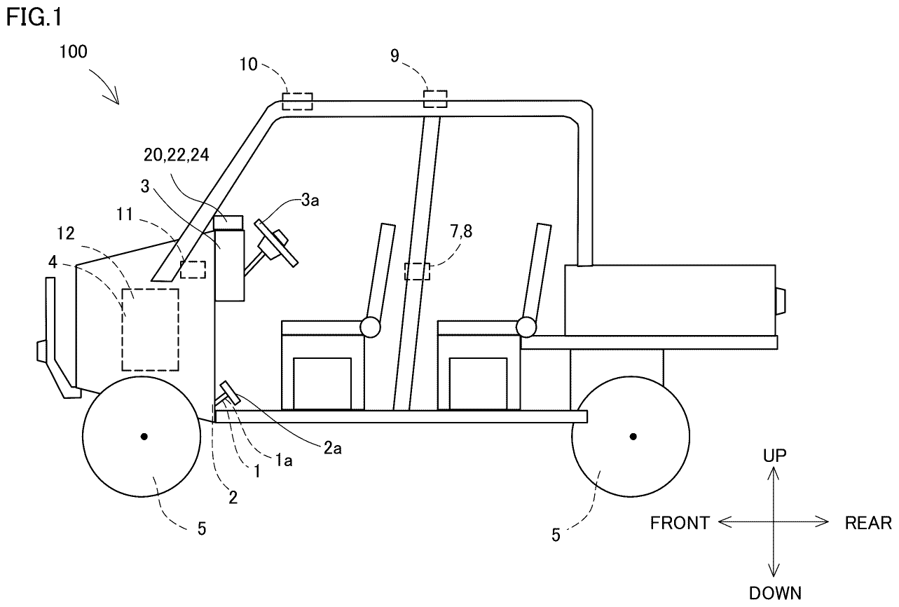

FIG. 1 is a schematic configuration view of a vehicle 100 according to an embodiment of the present disclosure. The vehicle 100 according to the present embodiment is an off-road vehicle that travels on rough terrain. The vehicle 100 is configured to be able to travel on terrain that is not paved, such as earth, mud, rocks and the like in a desert or a forest, for example.

The vehicle 100 includes a rollover protective structure (ROPS) and a cargo bed. The vehicle 100 is a so-called self-driving vehicle that can plan a route from a departure location to a target location, and can travel autonomously along the planned route. The autonomous travel is also referred to as automatic operation. The vehicle 100 is capable of unmanned autonomous travel in which a driver is not on board, or manned autonomous travel in which the driver is on board. Note that, in the present disclosure, the driver can also be referred to as a passenger, as appropriate.

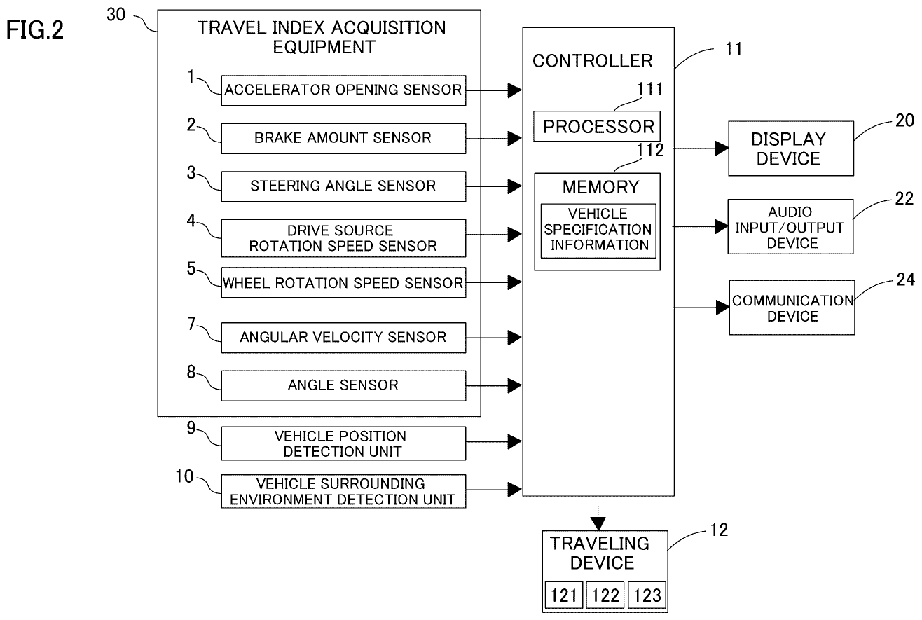

FIG. 2 is a schematic system configuration view of a vehicle. The vehicle 100 mainly includes a traveling device 12, travel index acquisition equipment 30, a vehicle position detection unit 9, a vehicle surrounding environment detection unit 10, a controller 11, a display device 20, an audio input/output device 22, and a communication device 24.

The traveling device 12 includes a drive device 121, a braking device 122, and a steering device 123. The drive device 121 is a device configured to output a drive force to be imparted to the vehicle 100, in order to cause the vehicle 100 to travel. The drive device 121 is, for example, an internal combustion engine, a motor, or the like. The braking device 122 is a device configured to output a braking force to be imparted to the vehicle 100, in order to brake the vehicle 100. The braking device 122 is a brake device, for example. The steering device 123 is a device configured to output a steering force to be imparted to the vehicle 100, in order to steer the vehicle 100. The steering device 123 is a steering mechanism, a steering unit, for example.

Note that, in FIG. 1 and the subsequent drawings, the vehicle 100 is exemplified by a configuration to which reference signs are allocated. Arrangements and sizes of each of the configurations (each of components) in the drawings do not represent actual arrangements and sizes.

As shown in FIG. 1, operation elements (operation devices) for operating the vehicle 100, such as a seat, an accelerator pedal 1a, a brake pedal 2a, a steering wheel 3a, and the like that are equipment for the driver, are installed in the vehicle 100. Note that when the autonomous travel is unmanned, this equipment for the driver need not necessarily be installed in the vehicle 100.

The travel index acquisition equipment 30 detects information indicating a traveling state of the vehicle 100. As shown in FIG. 2, for example, the travel index acquisition equipment 30 includes an accelerator opening sensor 1, a brake amount sensor 2, a steering angle sensor 3, a drive source rotation speed sensor 4, a wheel rotation speed sensor 5, an angular velocity sensor 7, and an angle sensor 8.

The accelerator opening sensor 1 detects an operation amount of the accelerator pedal 1a. The brake amount sensor 2 detects an operation amount of the brake pedal 2a. The steering angle sensor 3 detects an operation direction and an operation amount of the steering wheel 3a. During driving of the vehicle 100 by the driver, outputs from the drive device 121, the braking device 122, and the steering device 123 are performed in accordance with the operation amounts of the accelerator pedal 1a, the brake pedal 2a, the steering wheel 3a.

The drive source rotation speed sensor 4 detects a rotation speed of an output shaft of a drive source. The wheel rotation speed sensor 5 detects a rotation speed of a drive wheel. The wheel rotation speed sensor 5 may detect a rotation speed of a non-driven wheel. The angular velocity sensor 7 detects a wheel angular velocity. The angle sensor 8 is a gyro sensor, and detects a posture of the vehicle 100. The vehicle 100 may further include various sensors, such as a stroke sensor provided on a suspension or the like. The posture of the vehicle 100 may be estimated from a degree of acceleration obtained by performing an arithmetic operation on an expansion/contraction amount of the stroke sensor provided on the suspension and a detection result of the stroke sensor.

The vehicle position detection unit 9 (the vehicle position detector) is configured to detect the position of the vehicle 100. The position of the vehicle 100 can also be said to be a vehicle position, or a self-position. In the present embodiment, the vehicle position detection unit 9 includes a global navigation satellite system (GNSS). The vehicle position detection unit 9 may output, as the vehicle position, a position obtained by performing an arithmetic operation on detection results of a wheel velocity sensor, an inertial sensor, and the like. In addition to or in place of the GNSS, the vehicle position detection unit 9 may acquire position information of the vehicle 100 from a ground base station, via the communication device 24.

The vehicle surrounding environment detection unit 10 detects a route on which the vehicle 100 is to travel, and a situation surrounding the vehicle 100. The vehicle surrounding environment detection unit 10 includes a camera, for example. In addition to the camera, the vehicle surrounding environment detection unit 10 may include a distance sensor that uses radar, laser, infrared, sound waves, or the like.

The vehicle surrounding environment detection unit 10 includes a sensor that is able to detect irregularities and an inclination (gradient, ups and downs) of a road surface. Of the irregularities of the road surface, the vehicle surrounding environment detection unit 10 is preferably configured to be able to detect a protrusion having a width smaller than a vehicle width of the vehicle 100, and a recession having a width smaller than the vehicle width of the vehicle 100. Of the irregularities of the road surface, the protrusion having the width smaller than the vehicle width of the vehicle 100 will also be referred to as a road surface protrusion. Of the irregularities of the road surface, the recession having the width smaller than the vehicle width of the vehicle 100 will also be referred to as a road surface recession. The road surface protrusion may be a fallen tree or a fallen rock, for example. The road surface recession may be a crevice, a ditch, or a rut, for example.

The vehicle surrounding environment detection unit 10 is configured to be able to determine whether or not a height of the road surface protrusion is higher than a ground clearance of the vehicle 100. The ground clearance is a height of a bottom surface of the vehicle 100 from a ground contact surface of the tires of the vehicle 100. The vehicle surrounding environment detection unit 10 is preferably configured to detect a road width of the road surface that can be traveled on. The recognition of the road surface protrusions and the road surface recession in the vehicle surrounding environment detection unit 10 may be realized by a learning arithmetic operation using image processing.

The communication device 24 communicates with the outside of the vehicle 100 via a public network or the like. The communication with the outside of the vehicle 100 includes a management center of the vehicle 100, or a server device provided at a position separated from the vehicle 100. The communication device 24 need not necessarily be installed in the vehicle 100. The communication device 24 may be provided in a mobile device, such as a smartphone or a tablet terminal carried by the driver. The controller 11 may communicate with the outside of the vehicle 100 via the mobile device.

The display device 20 is a display of an instrument panel or a navigation device, for example. The audio input/output device 22 is a microphone and a speaker. The vehicle 100 can perform notification of information, such as the travel state of the vehicle 100, a warning, or the like, via the display device 20 and the audio input/output device 22, or the like. The vehicle 100 is configured to be able to allow the driver to input information relating to route planning, such as the current position, the target location and the like, via the display device 20 and the audio input/output device 22, or the like.

The controller 11 includes a processor 111 and a memory 112. The controller 11 is configured to be able to transmit and receive signals with each of the components of the vehicle 100. The detection results of the travel index acquisition equipment 30, the vehicle position detection unit 9, and the vehicle surrounding environment detection unit 10 are input to the controller 11, for example. The controller 11 outputs various commands (signals), for causing the vehicle 100 to travel autonomously, to the drive device 121, the braking device 122, and the steering device 123 of the traveling device 12, and causes the vehicle 100 to travel autonomously by controlling the drive device 121, the braking device 122, and the steering device 123. The commands output to the traveling device 12 from the controller 11 will also be referred to as travel commands, or autonomous commands. Further, the controller 11 can acquire various information from the display device 20 and the audio input/output device 22, and can output various information to the display device 20 and the audio input/output device 22.

The controller 11 van execute various processing. For example, the controller 11 decides (generates) the travel plan of the vehicle 100. The controller 11 controls the traveling device 12 such that the vehicle 100 travels autonomously in accordance with the decided travel plan. The travel plan includes the route from a departure location (current position) to the target location, and travel conditions, such as the vehicle speed, a drive state, and the like of the vehicle 100. The travel plan will also be referred to as a route plan or the route planning.

The controller 11 can accelerate and decelerate the vehicle 100, can steer the vehicle 100, and can execute switching of the drive state of the vehicle 100, and the like by controlling each of the components of the vehicle 100. The switching of the drive state includes switching from two-wheel drive to four-wheel drive of the vehicle 100, switching between a differential-free state and a differential-lock state, changing a gear ratio, switching between a forward movement state and a reverse movement state, and the like.

The controller 11 may decide (generate) the travel plan before the travel of the vehicle 100, may generate the travel plan during the travel of the vehicle 100, or may change the decided travel plan, as needed, during the travel of the vehicle 100. The changing of the travel plan may include traveling a detour route that makes a detour from the departure location to the target location, changing (suppressing) a decided travel speed, or the like.

Vehicle specification information that indicates the vehicle class or performance of the vehicle 100 is stored in advance in the memory 112. The vehicle specification information includes various information relating to the vehicle 100, such as a total length, a total width, a wheel diameter, a wheel base, and a designed minimum turning radius of the vehicle 100, and the like, for example.

Map information may be further stored in the memory 112. The map information may be acquired from outside via the communication device 24. The map information preferably includes information relating to the ups and downs and inclination of the road surface, and information that can be detected by the vehicle surrounding environment detection unit 10. The controller 11 may update the map information based on information and the like provided from a vehicle around the vehicle 100 and acquired by the communication device 24.

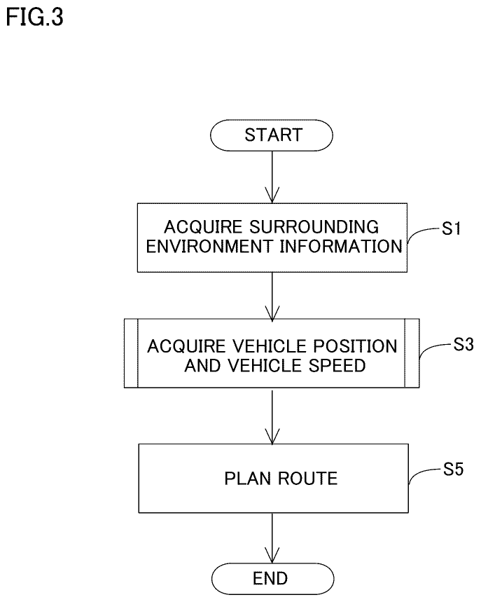

FIG. 3 is a flowchart showing an example of route planning processing executed by the processor 111 of the controller 11. For example, at a predetermined interval, the processor 111 of the controller 11 generates (decides) the route plan, which includes a departure position, the route from the current position to the target location, and the travel conditions such as the speed and drive state of the vehicle 100, and causes the vehicle 100 to travel autonomously based on the decided travel plan. Note that causing the vehicle 100 to travel autonomously based on the travel plan (the route) may mean causing the vehicle 100 to travel along the route, or may mean the processor 111 amending (correcting, changing) the route in the travel plan, in accordance with the road surface situation or the like.

At step S1, the processor 111 acquires surrounding environment information of the vehicle 100, via the vehicle surrounding environment detection unit 10.

At step S3, the processor 111 acquires the vehicle position and the vehicle speed.

At step S5, the controller 11 plans the travel route, which includes the route and the travel conditions, based on the information acquired at step S1 and step S3. The controller 11 controls the traveling device 12 such that the vehicle 100 travels autonomously in accordance with the plan.

In this way, the route planning is performed using the vehicle position and the vehicle speed acquired at step S3. The detection results of the travel index acquisition equipment 30 (travel-state detection unit), the vehicle position detection unit 9, and the vehicle surrounding environment detection unit 10 are output to the controller 11 at a predetermined interval, for example. Thus, the processor 111 can use the vehicle position acquired from the vehicle position detection unit 9 in the route planning. Furthermore, in the present embodiment, even when the processor 111 is not able to acquire the vehicle position from the vehicle position detection unit 9 for any reason, the processor 111 can estimate and acquire the vehicle position and execute the route planning. The estimation of the vehicle position is performed based on a slip state of the vehicle 100, namely, based on a state of slippage of the tires of the vehicle 100 on the ground contact surface (road surface). Hereinafter, vehicle position acquisition processing (step S3) in the route planning processing will be described in detail.

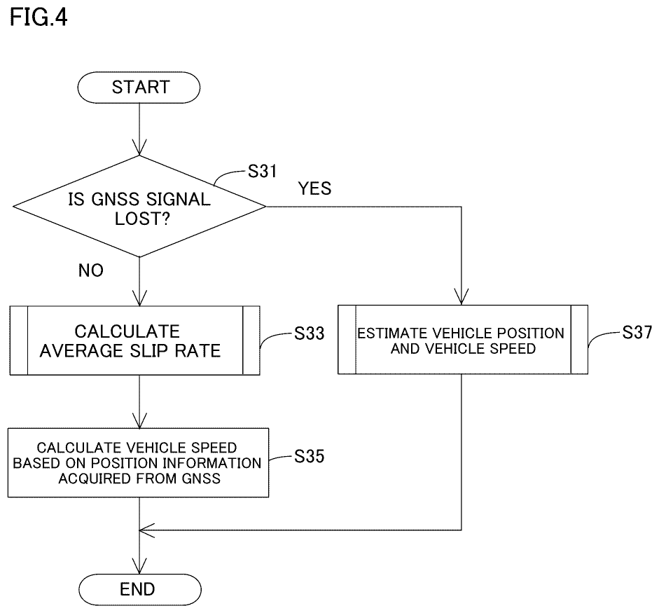

FIG. 4 is a flowchart showing an example of the processing at step S3 in the route planning processing shown in FIG. 3. At step S31, the processor 111 determines whether or not the signal of the vehicle position detection unit 9 has been lost. In the drawings from FIG. 4 onward, the detection result of the vehicle position detection unit 9 is exemplified by a GNSS signal, as the signal output from the vehicle position detection unit 9. The “signal has been lost” includes a case in which the processor 111 is unable to acquire the signal from the vehicle position detection unit 9 within a predetermined period. In the vehicle 100, a state in which the signal has been lost will also be referred to as a lost signal state.

When the signal from the vehicle position detection unit 9 has not been lost, namely, when the signal from the vehicle position detection unit 9 can be acquired, the processor 111 advances the processing to step S33, and calculates an average slip rate (slip ratio). The average slip rate is used in estimating the vehicle position and the vehicle speed when the vehicle 100 is in the lost signal state. Vehicle position and vehicle speed estimation processing will be described later.

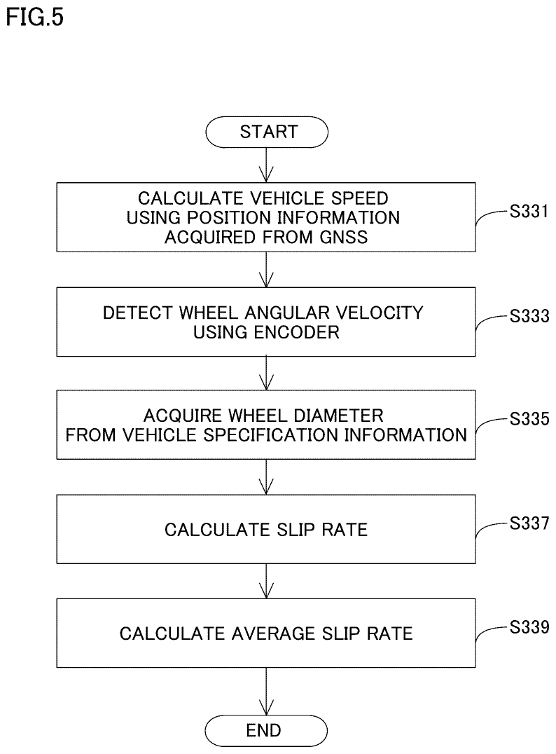

FIG. 5 is a flowchart showing an example of average slip rate calculation processing at step S33 shown in FIG. 4. First, at step S331, the processor 111 calculates the vehicle speed using the vehicle position acquired from the vehicle position detection unit 9.

At step S333, the processor 111 detects the wheel angular velocity, using an encoder. For example, the processor 111 detects the wheel angular velocity using an encoder of a sensor included in the travel index acquisition equipment 30. The encoder is the wheel rotation speed sensor 5, for example. At step S333, in place of the detection of the angular velocity by the wheel rotation speed sensor 5, the wheel angular velocity may be detected from the detection result of the drive source rotation speed sensor 4.

At step S335, the processor 111 refers to the vehicle specification information stored in the memory 112, and acquires the wheel diameter of the vehicle 100.

At step S337, the processor 111 uses the vehicle speed calculated at S331, the wheel angular velocity acquired at step S333, and the wheel diameter acquired at step S335, to calculate the slip rate using the following Formula 1.

$$Slip rate = \{ ( vehicle speed ) - ( wheel angular velocity ) \times ( wheel diameter ) \} \text{} / \{ ( wheel angular velocity ) \times ( wheel diameter ) \} \qquad Formula 1$$

The processor 111 stores the calculated slip rate in the memory 112. For example, the slip rate calculated within a predetermined period is stored in the memory 112 in a time-sequential manner. The slip rate can be any one of a positive value, zero, or a negative value, depending on the drive state (slip state) of the vehicle 100.

At step S339, the processor 111 calculates the average slip rate. The average slip rate is an average of the slip rate calculated at step S337 and the slip rate calculated in the past. The processor 111 stores the calculated average slip rate in the memory 112.

When the processing at step S339 ends, the processor 111 returns the processing to the vehicle position and vehicle speed acquisition processing shown in FIG. 4, and, at step S35, calculates the vehicle speed based on the vehicle position acquired from the vehicle position detection unit 9. For example, the processor 111 calculates the vehicle speed based on the vehicle position output at a predetermined cycle from the vehicle position detection unit 9 (GNSS).

As described above, when the vehicle 100 is not in the lost signal state (FIG. 4, no at step S31), the processor 111 acquires the vehicle position based on the GNSS signal, and the vehicle speed calculated at step S35 that is based on the GNSS signal. The processor 111 returns the acquired vehicle position and vehicle speed to the route planning processing (step S3, FIG. 3).

On the other hand, when the vehicle 100 is in the lost signal state (FIG. 4, yes at step S31), at step S37, the processor 111 estimates the vehicle position and the vehicle speed. At step S37, the processor 111 uses the average slip rate (FIG. 4, step S33, FIG. 5) to estimate the vehicle position and the vehicle speed.

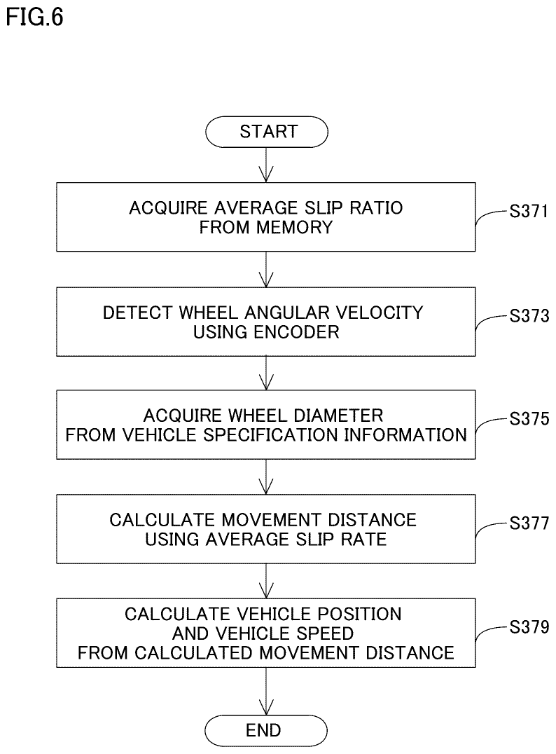

FIG. 6 is a flowchart showing an example of the vehicle position and vehicle speed estimation processing. At step S371, the processor 111 refers to the memory 112 and acquires the average slip rate.

At step S373, the processor 111 detects the wheel angular velocity. Further, at step S375, the processor 111 acquires the wheel diameter. The processing at steps S373 and S375 may be the same as the processing at the above-described steps S333 and S335, respectively.

At step S377, the processor 111 calculates a speed relating to the actual movement of the vehicle 100, using the following Formula 2, and calculates a movement distance by integrating the speed.

$$Movement speed = ( average slip rate + 1 ) \times ( wheel angular velocity ) \times ( wheel diameter ) \qquad Formula 2$$

The movement distance calculated at step S377 is, for example, a movement distance of the vehicle 100 within a predetermined period. The predetermined period is a period from after the vehicle position and vehicle speed acquisition processing (FIG. 3, step S3) is executed a preceding time to when the vehicle position and vehicle speed acquisition processing is executed a current time, for example.

Returning to FIG. 6, at step S379, the processor 111 calculates the vehicle position from the movement distance calculated at step S377. For example, the processor 111 calculates the vehicle position from the previous vehicle position and the movement distance calculated at step S377. Note that, at step S379, calculation of the vehicle speed may be omitted.

When the vehicle position and the vehicle speed are estimated, the processor 111 returns the estimated vehicle position and vehicle speed to the route planning processing (FIG. 3, step S3).

As described above, when the vehicle 100 is in the lost signal state (FIG. 4, yes at step S31), the processor 111 acquires the vehicle position and the vehicle speed using the average slip rate (FIG. 4, step S37, FIG. 6, steps S371 to S379). The processor 111 returns the estimated vehicle position and vehicle speed to the route planning processing (FIG. 3, step S3).

As described above, according to the vehicle 100 according to the present embodiment, based on the slip state of the vehicle 100, the processor 111 of the controller 11 estimates the vehicle position, and the vehicle speed that is based on the vehicle position of the vehicle 100. Thus, even when the vehicle 100 is in the lost signal state, the route planning can be executed using the estimated vehicle position and vehicle speed.

Further, in the vehicle 100 traveling over rough terrain, a case is conceivable in which, due to the influence of the topography or the like, time is required to detect the vehicle position by the vehicle position detection unit 9, or the detection is not possible. According to the present embodiment, even when the vehicle 100 is in the lost signal state, the vehicle position can be acquired, and thus, the vehicle 100 suitable for traveling over rough ground can be provided.

In the present embodiment, the GNSS signal is exemplified as the signal of the vehicle position detection unit 9, but the various above-described processing can be applied to a configuration using a signal of another sensor, such as an inertial sensor or the like, as the signal of the vehicle position detection unit 9. For example, the vehicle position may be estimated using a signal of a sensor that calculates the wheel speed, or the inertial sensor, for example. Note that using the GNSS signal is advantageous in terms of suppressing an influence of vibrations or the like of a vehicle body of the vehicle 100 on the estimation of the vehicle position.

With respect to the route planning processing, the vehicle position and vehicle speed acquisition processing, the average slip rate calculation processing, and the vehicle position and vehicle speed estimation processing according to the above-described embodiment, the controller 11 that executes the processing, and the vehicle 100 including the controller 11, various modifications are possible.

In the vehicle position and vehicle speed estimation processing, the processor 111 may estimate the vehicle position based on the slip state represented by the slippage of the tires of the vehicle 100 on the ground contact surface, regardless of the slip rate and average slip rate indicated by the above-described Formulas 1 and 2. The slip state may be determined, for example, from information relating to a time period in which the wheels are idling, or relating to the wheels that are idling and the wheels that are not idling. These pieces of information may be acquired from the wheel rotation speed sensor 5.

Predetermined slip rates may be stored in the memory 112. The processor 111 need not necessarily calculate the average slip rate, and may acquire the slip rate from the memory 112 and use that slip rate to execute the vehicle position and vehicle speed estimation processing.

The vehicle position and vehicle speed estimation processing may be executed when accuracy of the vehicle position represented by the signal is low, irrespective of whether the vehicle 100 is in the lost signal state.

For example, when the vehicle 100 is in the lost signal state (FIG. 4, yes at step S31), the processor 111 may execute vehicle speed limit processing that reduces the vehicle speed included in the travel conditions in the route planning at step S5. In the vehicle speed limit processing, the processor 111 may reduce the vehicle speed more compared to when the vehicle 100 is not in the lost signal state. Reducing the vehicle speed also means limiting the vehicle speed. For example, the processor 111 may limit the vehicle speed, which is equal to or greater than a lowest speed and equal to or lower than a maximum speed allowed in the environment in which the vehicle 100 is traveling, to a speed that can suppress deviation of the vehicle 100 from the planned route.

In the vehicle speed limit processing, the processor 111 may gradually reduce the vehicle speed over a predetermined time period (in stages) so as to reach a speed limit. When the vehicle speed has reached the speed limit, the processor 111 may cause the vehicle 100 to travel so as to maintain the speed limit.

In the vehicle speed limit processing, when the vehicle 100 is in the lost signal state (FIG. 4, yes at step S31), the processor 111 may limit the vehicle speed in accordance with a time period (period) over which the signal is lost. For example, the longer the time period over which the signal is lost, the more the processor 111 may reduce the vehicle speed.

In the vehicle speed limit processing, when the signal is lost (FIG. 4, yes at step S31) and thereafter, the signal can once again be acquired, the processor 111 may release the limit on the vehicle speed. In this case, the processor 111 may gradually increase the vehicle speed, for example, to the maximum speed allowed on the route of the vehicle 100.

When the vehicle 100 is in the lost signal state (FIG. 4, yes at step S31), the processor 111 may notify the driver of the lost signal state. For example, the processor 111 may output information indicating that the signal has been lost from at least one of the display device 20 and the audio input/output device 22. The processor 111 may display the information on the display of the display device 20, or may output the information from the speaker of the audio input/output device 22.

When the vehicle 100 is in the lost signal state (FIG. 4, yes at step S31), the processor 111 may notify the external management center, via the communication device 24, of information indicating the signal lost state. When the vehicle 100 is traveling in a group (group travel) in which a plurality of vehicles form a group and travel together, the processor 111 may notify another of the vehicles included in the vehicle group of the lost signal state. The other vehicle may be a representative vehicle established at the time of group travel.

A correspondence between each of structural elements (features) of the above-described embodiment and each of structural elements (features) of the present disclosure is as described below. Note that each of the structural elements of the embodiment are merely examples, and are not intended to limit each of the structural elements of the present disclosure. The vehicle 100 is an example of a “vehicle”. The controller 11 and the processor 111 are an example of a “controller”. The slip rate and the average slip rate are an example of a “slip state”. The vehicle position detection unit 9 is an example of a “vehicle position detection unit”. The traveling device 12 is an example of a “traveling device”. The display device 20 and the audio input/output device 22 are an example of a “notification device”. The communication device 24 is an example of a “communication device”.

The functionality of the elements disclosed herein may be implemented using one or more circuitry or processing circuitry which includes general purpose processors, special purpose processors, integrated circuits, ASICs (“Application Specific Integrated Circuits”), FPGAs (“Field Programmable Gate Arrays”) and/or conventional circuitry. The functionality of the elements disclosed herein may be implemented using one or more circuitry or processing circuitry which includes combinations of general purpose processors, special purpose processors, integrated circuits, ASICs, FPGAs, or conventional circuitry. The one or more circuitry or processing circuitry is programmed, using one or more programs stored together or individually in one or more memories, or otherwise configured to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality, alone or in combination with one another. The hardware may be any hardware disclosed herein which is programmed or configured to carry out the recited functionality. There is a memory that stores a computer program which includes computer instructions. The computer instructions provide the logic and routines that enable the hardware to perform the method disclosed herein. The hardware includes, e.g., processing circuitry or circuitry. The computer program can be implemented in known formats as a computer readable storage medium, a computer program product, a memory device, a record medium such as a CD-ROM or DVD, and/or the memory of a FPGAs or ASICs.

The present disclosure is not limited to the above-described embodiment and modified examples, and can be realized by various other aspects insofar as these do not depart from the gist and scope thereof. For example, the present disclosure can be realized by the following aspects. Each of technical features in the above-described embodiment and modified examples corresponding to technical features of each of the aspects described below can be switched or combined, as appropriate, in order to solve some or all of the issues of the present disclosure, or to achieve some or all of the effects of the present disclosure. Further, insofar as these technical features are not described as essential in the present specification, they may be omitted as appropriate.
(1) According to a first aspect of the present disclosure, a vehicle is provided. The vehicle is an off-road vehicle capable of traveling over rough terrain. The vehicle includes a controller. The controller is configured to estimate a vehicle position based on a slip state of the vehicle, the vehicle position being a current position of the vehicle.

According to this aspect, the controller can estimate the vehicle position based on the slip state of the vehicle. Thus, the controller can utilize the estimated vehicle position in control (travel) and the like of the vehicle.

In this aspect, the slip state of the vehicle may be an index indicating a state of slippage of tires of the vehicle with a road surface (a tire ground contact surface).

The slip state of the vehicle may be a vehicle slip rate, may be a vehicle average slip rate, or may be a vehicle wheel idling state.

In this aspect, the vehicle may include a traveling device that causes the vehicle to travel. The vehicle may be configured to travel autonomously as a result of control of the traveling device by the controller. The controller may use the vehicle position to execute travel planning that includes a route for causing the vehicle to travel autonomously.
(2) In the above-described aspect, the controller may use the vehicle slip rate as the slip state.

According to this aspect, the vehicle position can be estimated using the slip rate that represents an extent of slippage of the tires of the vehicle on the road surface.
(3) In the above-described aspect, the vehicle may include a vehicle position detection unit configured to detect the vehicle position and output the vehicle position to the controller. The controller may estimate the vehicle position when the vehicle is in a lost signal state of the vehicle position not being acquirable from the vehicle position detection unit.

According to this aspect, even when the vehicle is in the lost signal state, the vehicle position can be acquired by estimating the vehicle position.
(4) In the above-described aspect, the controller may calculate the slip rate based on the vehicle position acquired from the vehicle position detection unit when the vehicle is not in the lost signal state.

According to this aspect, the vehicle position when the vehicle is in the lost signal state can be estimated using the slip rate based on the vehicle position detected by the vehicle position detection unit.
(5) In the above-described aspect, the controller may calculate an average slip rate based on the vehicle position acquired from the vehicle position detection unit over a predetermined period when the vehicle is not in the lost signal state, the average slip rate being an average of the slip rate. The controller may estimate the vehicle position using the average slip rate, when the vehicle is in the lost signal state.

According to this aspect, the vehicle position when the vehicle is in the lost signal state can be estimated using the slip rate based on the vehicle position detected by the vehicle position detection unit.
(6) In the above-described aspect, the vehicle may include a traveling device configured to cause the vehicle to travel. The vehicle may be configured to be able to travel autonomously as a result of the controller controlling the traveling device. The controller may be configured to control the traveling device and reduce a vehicle speed of the vehicle when the vehicle is in a lost signal state of the vehicle position not being acquirable from the vehicle position detection unit.

According to this aspect, even when the vehicle is in the lost signal state, the vehicle can be caused to travel autonomously by estimating the vehicle position based on the slip state of the vehicle. Furthermore, since the vehicle speed is reduced when the vehicle is in the lost signal state, stable autonomous traveling is realized in the lost signal state also.
(7) In the above-described aspect, the controller may acquire the vehicle position at a predetermined cycle. The acquiring the vehicle position may include (i) acquiring the vehicle position from the vehicle position detection unit, when the vehicle is not in the lost signal state, and (ii) acquiring the vehicle position estimated based on the average slip rate, when the vehicle is in the lost signal state. When the vehicle is in the lost signal state, the controller may be configured to estimate the vehicle position using the vehicle position acquired at a preceding cycle and using the average slip rate.

According to this aspect, when the vehicle is in the lost signal state, the vehicle position can be estimated using the preceding vehicle position information and the average slip rate.

In the above-described aspect, the vehicle may include a traveling device configured to cause the vehicle to travel. The vehicle may be configured to be able to travel autonomously as a result of the controller controlling the traveling device. The controller may plan a route to cause the vehicle to reach a predetermined target position, and may control the traveling device to cause the vehicle to travel based on the route. The controller may plan the route using the acquired vehicle position.

According to this aspect, the route is planned using the estimated vehicle position even when the vehicle is in the lost signal state, and the vehicle can be provided that is capable of traveling autonomously along the route.
(9) In the above-described aspect, the vehicle position detection unit may be configured to output a GNSS signal, as the vehicle position, to the controller.

According to this aspect, even when, due to the influence of the topography or the like, time is required to detect the vehicle position by the vehicle position detection unit, or detection is not possible, the vehicle position is estimated when the GNSS signal is lost, using the slip rate calculated based on the GNSS signal when the GNSS signal is not lost. Thus, compared to a configuration in which the vehicle position is interpolated using a wheel rotation speed or a signal from an inertial sensor, estimation accuracy of the vehicle position can be improved.
(10) According to a second aspect of the present disclosure, a vehicle is provided. The vehicle is an off-road vehicle capable of traveling over rough terrain. The vehicle includes a traveling device configured to cause the vehicle to travel, a controller configured to control the traveling device and cause the vehicle to travel autonomously, and a vehicle position detection unit configured to detect a vehicle position and output the vehicle position to the controller, the vehicle position being a current position of the vehicle. When the vehicle is in a lost signal state of the vehicle position not being acquirable from the vehicle position detection unit, the controller is configured to execute vehicle speed limit processing that reduces a vehicle speed of the vehicle.

According to this aspect, the vehicle can be provided that is capable of traveling while reducing the vehicle speed in the lost signal state.
(11) In the above-described aspect, in the vehicle speed limit processing, the controller may reduce the vehicle speed more compared to when the vehicle is not in the lost signal state.

According to this aspect, the vehicle can be provided that is capable of traveling while reducing the vehicle speed more in the lost signal state, compared to when not in the lost signal state.
(12) In the above-described aspect, in the vehicle speed limit processing, the controller may reduce the vehicle speed in stages, to cause the vehicle speed to reach a predetermined speed within a predetermined period.

According to this aspect, the vehicle speed can be suppressed from rapidly decreasing when the vehicle is in the lost signal state.
(13) In the above-described aspect, the controller may control the traveling device to cause the vehicle to travel autonomously on a planned route. In the vehicle speed limit processing, the controller may reduce the vehicle speed to cause the vehicle speed to be a minimum speed established for the planned route.

According to this aspect, the vehicle can be provided that is capable of traveling autonomously while reducing the vehicle speed in the lost signal state.
(14) In the above-described aspect, in the vehicle speed limit processing, the longer a time period of the lost signal state, the more the controller may reduce the vehicle speed.

According to this aspect, the vehicle speed can be reduced in accordance with the period of the lost signal state.

In the above-described aspect, the controller may cancel the vehicle speed limit processing when, subsequent to the vehicle being in the lost signal state, the signal from the vehicle position detection unit is restored, and the vehicle position is acquirable from the vehicle position detection unit.

According to this aspect, the vehicle can be provided that is capable of traveling at a suitable speed, in accordance with whether or not the vehicle is in the lost signal state.
(16) In the above-described aspect, the vehicle may include a notification device configured to notify information relating to the vehicle. When the vehicle is in the lost signal state, the controller may be configured to issue information notifying that the vehicle is in the lost signal state, via the notification device.

According to this aspect, a driver can ascertain a possibility that the decrease in the vehicle speed is a result of the lost signal state.
(17) In the above-described aspect, the vehicle may include a communication device configured to be able to communicate with an external device provided outside the vehicle and managed by an administrator of the vehicle. When the vehicle is in the lost signal state, the controller may be configured to output information notifying that the vehicle is in the lost signal state, to the external device via the communication device.

According to this aspect, the administrator can ascertain that the vehicle has lost the signal.
(18) According to the above-described aspect, the vehicle position detection unit may output a GNSS signal, as the vehicle position, to the controller.

According to this aspect, the vehicle can be provided that is capable of reducing the vehicle speed and traveling when the GNSS signal is lost.

What is claimed is:

1. A vehicle comprising:
a controller, wherein
the vehicle is an off-road vehicle configured to be able to travel over rough terrain, and
the controller is configured to estimate a vehicle position based on a slip state of the vehicle, the vehicle position being a current position of the vehicle.

2. The vehicle according to claim 1, wherein
the controller uses a slip rate of the vehicle as the slip state.

3. The vehicle according to claim 1, comprising:
a vehicle position detection unit configured to detect the vehicle position, wherein
the controller estimates the vehicle position, when the vehicle is in a lost signal state of the vehicle position not being acquirable from the vehicle position detection unit.

4. The vehicle according to claim 3, wherein
the controller calculates the slip rate based on the vehicle position acquired from the vehicle position detection unit when the vehicle is not in the lost signal state.

5. The vehicle according to claim 3, wherein
the controller calculates an average slip rate based on the vehicle position acquired from the vehicle position detection unit over a predetermined period when the vehicle is not in the lost signal state, the average slip rate being an average of the slip rate, and
the controller estimates the vehicle position using the average slip rate, when the vehicle is in the lost signal state.

6. The vehicle according to claim 1, comprising:
a vehicle position detection unit configured to detect the vehicle position; and
a traveling device configured to cause the vehicle to travel, wherein
the vehicle is configured to be able to travel autonomously as a result of the controller controlling the traveling device, and
the controller controls the traveling device and reduces a vehicle speed of the vehicle, when the vehicle is in a lost signal state of the vehicle position not being acquirable from the vehicle position detection unit.

7. The vehicle according to claim 5, wherein
the controller acquires the vehicle position at a predetermined cycle,
the acquiring the vehicle position includes
acquiring the vehicle position from the vehicle position detection unit, when the vehicle is not in the lost signal state, and
acquiring the vehicle position estimated based on the average slip rate, when the vehicle is in the lost signal state, and
when the vehicle is in the lost signal state, the controller estimates the vehicle position using the vehicle position acquired at a preceding cycle, and using the average slip rate.

8. The vehicle according to claim 7, comprising:
a traveling device configured to cause the vehicle to travel, wherein
the vehicle is configured to be able to travel autonomously as a result of the controller controlling the traveling device,
the controller plans a route to cause the vehicle to reach a predetermined target position, and controls the traveling device to cause the vehicle to travel based on the route, and
the controller plans the route using the acquired vehicle position.

9. The vehicle according to claim 3, wherein
the vehicle position detection unit outputs a GNSS signal, as the vehicle position, to the controller.

10. A vehicle comprising:
a traveling device configured to cause the vehicle to travel;
a controller configured to control the traveling device and cause the vehicle to travel autonomously; and
a vehicle position detection unit configured to detect a vehicle position and output the vehicle position to the controller, the vehicle position being a current position of the vehicle, wherein
the vehicle is an off-road vehicle capable of traveling over rough terrain, and
when the vehicle is in a lost signal state of the vehicle position not being acquirable from the vehicle position detection unit, the controller executes vehicle speed limit processing that reduces a vehicle speed of the vehicle.

11. The vehicle according to claim 10, wherein
in the vehicle speed limit processing, the controller reduces the vehicle speed more compared to when the vehicle is not in the lost signal state.

12. The vehicle according to claim 10, wherein
in the vehicle speed limit processing, the controller reduces the vehicle speed in stages, to cause the vehicle speed to reach a predetermined speed within a predetermined period.

13. The vehicle according to claim 10, wherein
the controller controls the traveling device to cause the vehicle to travel autonomously on a planned route, and
in the vehicle speed limit processing, the controller reduces the vehicle speed to cause the vehicle speed to be a minimum speed established for the planned route.

14. The vehicle according to claim 10, wherein
in the vehicle speed limit processing, the longer a time period of the lost signal state, the more the controller reduces the vehicle speed.

15. The vehicle according to claim 10, wherein
the controller cancels the vehicle speed limit processing when, subsequent to the vehicle being in the lost signal state, the vehicle position is acquirable from the vehicle position detection unit.

16. The vehicle according to claim 10, comprising:
a notification device configured to notify information relating to the vehicle, wherein
when the vehicle is in the lost signal state, the controller issues information notifying that the vehicle is in the lost signal state, via the notification device.

17. The vehicle according to claim 10, comprising:
a communication device configured to be able to communicate with an external device provided outside the vehicle and managed by an administrator of the vehicle, wherein
when the vehicle is in the lost signal state, the controller outputs information notifying that the vehicle is in the lost signal state, to the external device via the communication device.

18. The vehicle according to claim 10, wherein
the vehicle position detection unit outputs a GNSS signal, as the vehicle position, to the controller.
